(19) United States
(12) Patent Application Publication
(10) Pub. No.: US 2026/0178187 A1
(43) Pub. Date: Jun. 25, 2026

(54) SYSTEMS AND METHODS ENABLING MULTIPLE SIZE-BASED TOUCH GESTURES FOR A TOUCH-SENSITIVE DISPLAY SCREEN

(71) Applicant: Dell Products L.P., Round Rock, TX (US)

(72) Inventors: Kai Wang, Shanghai (CN); Jimmy L. Griffith, Pflugerville, TX (US); David Allen Dyson, Pflugerville, TX (US)

(73) Assignee: Dell Products L.P., Round Rock, TX (US)

(21) Appl. No.: 18/927,061

(22) Filed: Oct. 25, 2024

(51) Int. Cl. G06F 3/04883

(52) U.S. Cl. CPC G06F 3/04883; G06F 2203/04808

(57) ABSTRACT

A gesture application may define a set of size-based touch gestures. Each one of the size-based touch gestures may correspond to a size and may also correspond to a part of a human user's hand. The gesture application, through the addition of size-based touch gestures, may add functionality to a computer system, such as by facilitating the use of different ones of the size-based touch gestures to perform different functions.

### FIELD

This disclosure relates generally to Information Handling Systems (IHSs), and more specifically, to systems and methods for enabling multiple size-based touch gestures for a touch-sensitive display screen.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

According to an embodiment, a method includes: maintaining a store of category data, wherein the category data defines a plurality of size-based touch gestures; detecting user interaction with a touch-sensitive display screen; classifying the user interaction according to the category data, including determining that the user interaction corresponds to a first size-based touch gesture of the plurality of size-based touch gestures; and controlling an action of the touch sensitive display screen based upon determining that the user interaction corresponds to the first size-based touch gesture.

According to an embodiment, an information handling system (IHS) includes: a processor; and a memory coupled to the processor, the memory having program instructions stored thereon that, upon execution by the processor, cause the IHS to: receive digital input corresponding to a physical touch by a part of a human hand upon a display screen of the IHS; classify the physical touch as a first size-based touch gesture, from a plurality of size-based touch gestures, including performing a matching operation between the physical touch and a store of data that defines the plurality of size-based touch gestures; and perform a first action upon the display screen, wherein the first action has been pre-programmed to correspond to the first size-based touch gesture.

According to an embodiment, a hardware memory device has program instructions stored thereon that, upon execution by a processor of an IHS, cause the IHS to: receive digital input corresponding to a physical touch by a part of a human hand upon a display screen of the IHS, wherein the digital input identifies a width and a height of the physical touch; perform a matching operation on the digital input with respect to a plurality of pre-defined size-based touch gestures, including determining that the width and the height of the physical touch matches a first size-based touch gesture of the plurality of pre-defined size-based touch gestures; and perform a first action upon the display screen, wherein the first action has been pre-programmed to correspond to the first size-based touch gesture.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity and have not necessarily been drawn to scale.

FIG. 1 is a block diagram of components of an example Information Handling System (IHS), according to some embodiments.

FIG. 2 illustrates example size-based touch gestures, which may be defined and acted upon by the gesture application of FIG. 1, according to some embodiments.

FIG. 3 is an illustration of example X and Y coordinates (width and height coordinates), that may be sensed by sense nodes of an example display screen, according to some embodiments.

FIG. 4 illustrates example gestures, which may be performed on an example display screen, according to some embodiments.

FIG. 5 is an illustration of example lines, drawn by a human user upon a display screen, using an example gesture application, according to some embodiments.

FIG. 6 is an illustration of an example accessibility mode, which may be associated with a gesture application, according to some embodiments.

FIG. 7 is an illustration of different example modes, which may be implemented by a gesture application, according to some embodiments.

FIG. 8 is an illustration of an example method, which may be performed by a gesture application, according to some embodiments.

FIG. 9 is an illustration of an example settings screen, which may be displayed upon a graphical user interface on a display device, according to various embodiments.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An example of an IHS is described in more detail below. It should be appreciated that although certain embodiments are discussed in the context of a personal computing device, other embodiments may utilize various other types of IHSs.

Some more advanced drawing applications, such as digital whiteboards, may offer the user a choice of drawing line widths, drawing line colors, and the like. However, a user's access to such options may be through a pulldown menu, a dial totem, or other technique. While those access techniques may be satisfactory for some users and use cases, other users and use cases may benefit from easier access techniques.

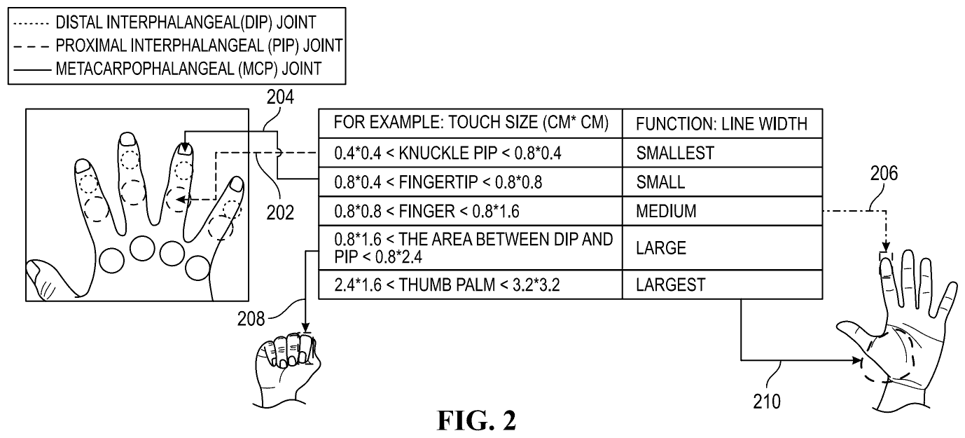

One example embodiment allows for multiple size-based touch gestures for use with a touch-sensitive display screen. In one example, an application may maintain a store of category data, where that category data defines a plurality of size-based touch gestures. Examples of size-based touch gestures are described in more detail with respect to FIG. 2-4 and 6. The application may detect user interaction with a touch-sensitive display screen, such as when a user physically touches a part of the user's hand to a surface of the display screen. The display screen may be implemented according to a technology, such as capacitive touch detection, which enables the display screen to detect the user interaction. The display screen may detect size information, such as a quantity of pixels or other unit that corresponds to the portion of the user's hand which is in contact with the surface of the display screen. The display screen may detect shape information as well, where that shape information may define a shape of the portion of the user's hand which is in contact with the surface of the display screen. An example of shape information may include a length and width dimension in some instances.

Continuing with the example, the application may classify the user interaction according to the category data. In one example, the application may determine that the user interaction corresponds to one of the size-based touch gestures from the store of category data. The application may attempt a best match of the size information and/or shape information to one or more of the size-based touch gestures.

The application may then control an action of the touch sensitive display screen based upon determining that the user interaction corresponds to the particular size-based touch gesture. The addition of size-based touch gestures to a roster of other user input modes may allow for a greater degree of control by a user over actions on the screen, as well as increased convenience for the user in some instances. In one example, one or more of the size-based touch gestures may correspond to a fine line width in a drawing application, another of the size-based touch gestures may correspond to greater line width in the drawing application, thereby allowing the user to select line widths by using different gestures. Of course, the scope of implementations may include any appropriate action upon the touch sensitive display screen or other action by an IHS in response to detecting a gesture.

Furthermore, some embodiments may allow for a greater degree of defining touch gestures and training an IHS to recognize touch gestures. A potential advantage of a greater degree of defining and training for touch gestures may be that people who have hand accessibility problems may be able to define touch gestures that work for their hands.

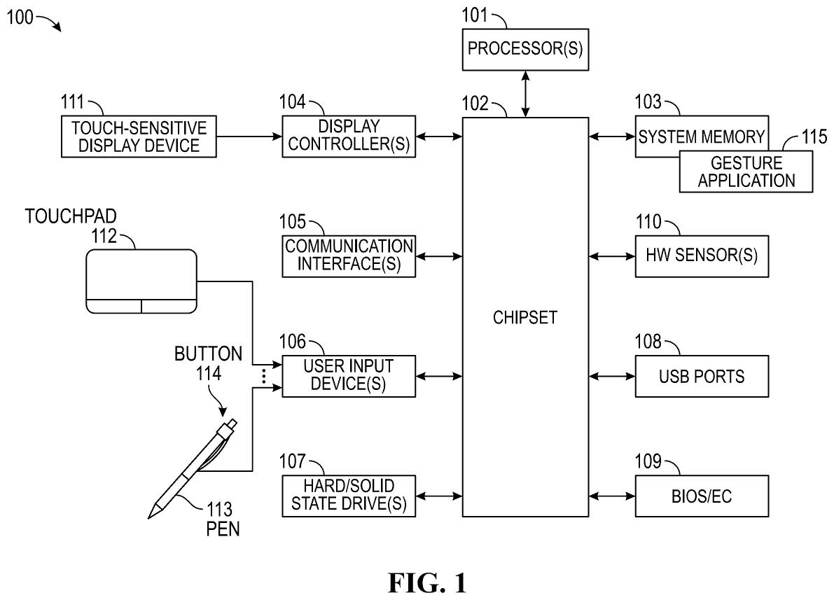

FIG. 1 is a block diagram of components of IHS 100, according to some embodiments. As depicted, IHS 100 includes processor 101. In various embodiments, IHS 100 may be a single-processor system, or a multi-processor system including two or more processors. Processor 101 may include any processor capable of executing program instructions, such as a PENTIUM series processor, or any general-purpose or embedded processors implementing any of a variety of Instruction Set Architectures (ISAs), such as an x86 ISA or a Reduced Instruction Set Computer (RISC) ISA (e.g., POWERPC, ARM, SPARC, MIPS, etc.).

IHS 100 includes chipset 102 coupled to processor 101. Chipset 102 may provide processor 101 with access to several resources. In some cases, chipset 102 may utilize a QuickPath Interconnect (QPI) bus to communicate with processor 101. Chipset 102 may also be coupled to communication interface(s) 105 to enable communications between IHS 100 and various wired and/or wireless networks, such as Ethernet, WiFi, BLUETOOTH, cellular or mobile networks (e.g., CDMA, TDMA, LTE, etc.), satellite networks, or the like. In some cases, communication interface(s) 105 may be coupled to chipset 102 via a PCIe bus.

Chipset 102 may be coupled to display controller(s) 104, which may include one or more or graphics processor(s) (GPUs) on a graphics bus, such as an Accelerated Graphics Port (AGP) or Peripheral Component Interconnect Express (PCIe) bus. As shown, display controller(s) 104 provide video or display signals to display device 111. In other implementations, any number of display controllers or display devices may be used.

Display device 111 may include Liquid Crystal Display (LCD), Light Emitting Diode (LED), organic LED (OLED), or other thin film display technologies. Display device 111 may include a plurality of pixels arranged in a matrix, configured to display visual information, such as text, two-dimensional images, video, three-dimensional images, etc. In some cases, display device 111 may be provided as a single continuous display, rather than two discrete displays. Display device 111 is configured as a touch-sensitive display device, enabled to detect a touch from a human user and to transmit data representing the touch to display controller 104. Display controller 104 may process the data and then transmit the data to processors 101. Display device 111 may include one or more separate layers of touch-sensing sensor circuitry (e.g., capacitive layers, resistive layers technology, surface acoustic wave transducers, etc.) that define at least one planar touch-sensing layer that overlies at least a portion of the visual display area of the screen of display device 111 in stacked layered parallel relationship, with the plane of the screen disposed parallel to the plane of the planar touch-sensing layer. In some examples, a planar touch-sensing layer may either physically contact a layer of the screen or may overlie (or overlap) the area of the screen with other layers disposed therebetween.

In one example, when a human user touches a particular location on the touch-sensing layer, a touch event may be detected by the display controller 104 at one or more sense nodes of the touch sensing layer by detecting a change in the signal charge caused by a change in the capacitance induced across one or more of its sense nodes at that current particular touched location (e.g., at X, Y coordinate position/s corresponding to the current particular touched location). The display controller may change the detected signal charges into digital data. Furthermore, as the user moves a finger across the screen, the movement of the physical touch may be tracked and digitized as well.

Chipset 102 may provide processor 101 and/or display controller(s) 104 with access to system memory 103. In various embodiments, system memory 103 may be implemented using any suitable memory technology, such as static RAM (SRAM), dynamic RAM (DRAM) or magnetic disks, or any nonvolatile/Flash-type memory, such as a solid-state drive (SSD) or the like. Memory 103 may store program instructions that, upon execution by processor 101, cause the IHS 100 to perform the functions of an application.

Chipset 102 may also provide access to one or more hard disk and/or solid-state drives 107. In certain embodiments, chipset 102 may also provide access to one or more optical drives or other removable-media drives. In certain embodiments, chipset 102 may also provide access to one or more Universal Serial Bus (USB) ports 108.

Chipset 102 may further provide access to one or more user input devices 106, for example, using a super I/O controller or the like. Examples of user input devices 106 include, but are not limited to, a keyboard, mouse, touchpad 112, stylus or active pen 113 (with button or switch 114), dial totem, etc. Each of user input devices 106 may include a respective controller (e.g., a touchpad may have its own touchpad controller) that interfaces with chipset 102 through a wired or wireless connection (e.g., via communication interfaces(s) 105).

In certain embodiments, chipset 102 may also provide an interface for communications with one or more hardware sensors 110. Sensors 110 may be disposed on or within the chassis of IHS 100, and may include, but are not limited to: electric, magnetic, radio, optical, infrared, thermal, force, pressure, acoustic, ultrasonic, proximity, position, deformation, bending, direction, movement, velocity, rotation, and/or acceleration sensor(s).

Upon booting of IHS 100, processor(s) 101 may utilize Basic Input/Output System (BIOS) instructions of BIOS/Embedded Controller (EC) 109 to initialize and test hardware components coupled to IHS 100 and to load an OS for use by IHS 100. The BIOS provides an abstraction layer that allows the OS to interface with certain hardware components that are utilized by IHS 100. Via the hardware abstraction layer provided by the BIOS, software stored in system memory 103 and executed by processor 101 can interface with certain I/O devices that are coupled to IHS 100. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

EC 109 may be installed as a Trusted Execution Environment (TEE) component to the motherboard of IHS 100. EC 109 may implement operations for interfacing with a power adapter in managing power for IHS 100. Such operations may be utilized to determine the power status of IHS 100, such as whether IHS 100 is operating from battery power or is plugged into an AC power source. Firmware instructions utilized by EC 109 may be used to provide various core operations of IHS 100, such as power management and management of certain modes of IHS 100 (e.g., turbo modes, maximum operating clock frequencies of certain components, etc.).

Further in this example, the system memory 103 includes computer executable code for gesture application 115. When the processors 101 read and execute the code of the gesture application 115, the processors 101 may perform functions defined by the gesture application 115. Gesture application 115 may define a multitude of different size-based touch gestures, associate each of those different size-based touch gestures with actions, maintain a store of category data, and associate touch input with one or more size-based touch gestures using the store of category data. This is described in more detail with respect to FIGS. 2-9. Memory 103 may also be used to store the category data.

In other embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components. For example, all or a portion of the operations executed by the illustrated components may instead be provided by components integrated into processor(s) 101 as systems-on-a-chip. As such, in certain embodiments, IHS 100 may be implemented as different classes of computing devices including, but not limited to: servers, workstations, desktops, laptops, appliances, video game consoles, tablets, smartphones, etc.

FIG. 2 illustrates example size-based touch gestures, which may be defined and acted upon by the gesture application 115 of FIG. 1, according to some embodiments. One example may include training or calibrating gesture application 115 to recognize multiple size-based touch gestures. As described above, when a user physically touches the touch sensitive display device 111, multiple sense nodes may change a charge, thereby allowing the touch to be detected. The sense nodes may be arranged in a grid in the touch sensing layer, and a given physical touch from a human user may be detected by multiple ones of the sense nodes. For a given touch on the screen, that touch may be described by a shape of the affected sense nodes and a quantity of the affected sense nodes. One way to describe the shape and the quantity of the affected sense nodes is to use X and Y coordinates, to define a width and a height, though the scope of implementations may include more nuanced shapes, such as including curves. In any event, the particular affected sense nodes may change a charge and in addition to generating an indication of a touch, the display controller 104 may also register a quantity and/or shape of the affected sense nodes, such as using X and Y coordinates. The display controller 104 may transfer those X and Y coordinates to the gesture application 115.

Training or calibrating the gesture application 115 may include a human user touching a finger or knuckle or other part of the hand to the display device 111, indicating to the gesture application 115 which part of the hand and/or which gesture of the touch corresponds to, and repeating as many times as is appropriate to train and/or calibrate the gesture application 115. In one example, the gesture application 115 may include a machine learning (ML) model, which may be trained through such input to recognize a plurality of different size-based touch gestures.

In one example, a k-nearest neighbors (KNN) algorithm may be trained on a plurality of class labels. Each individual class label may correspond to a respective size-based touch gesture. The training data set along with the associated class labels may be stored in any appropriate manner, such as in a database, at memory 103. Such training data set and associated class labels may function as a store of category data, which may define the multitude of size-based touch gestures. Of course, the scope of implementations is not limited to any particular technique to define multiple size-based touch gestures and to maintain a store of category data, as other methods, such as a non-ML matching algorithm with calibrated profiles may also be used.

FIG. 2 illustrates example size-based touch gestures 202, 204, 206, 208, 210. A knuckle proximal interphalangeal (PIP) joint touch gesture 202 may be associated with a size of between 0.4 cm*0.4 cm and 0.8 cm*0.4 cm. The knuckle PIP touch gesture 202 may include a human user bending a finger at the PIP joint and touching the display screen 111 with the knuckle of the PIP joint. An example knuckle PIP gesture 202 is illustrated in FIG. 4. The scope of implementations is not limited to single gestures, as a gesture using multiple PIP gestures 202 is shown as gesture 402 in FIG. 4.

A fingertip gesture 204 may be associated with a size between 0.8 cm*0.4 cm and 0.8 cm*0.8 cm, which is larger than the knuckle PIP gesture 202. A fingertip gesture may include a user touching display screen 111 with a tip of the finger by the fingernail, rather than the pad of the finger.

A finger touch gesture 206 may be associated with a size between 0.8 cm*0.8 cm and 0.8 cm*1.6 cm. The finger touch gesture 206 may include a human user touching display screen 111 with a pad of the finger, which corresponds to an area larger than that of the fingertip gesture 204. An example fingertip gesture 204 or finger touch gesture 206 is illustrated in FIG. 4, and the gesture 204 or 206 may depend on the part of the finger that the user uses to touch the surface of the display screen 111.

Gesture 208 may be made with the area of a finger between the distal interphalangeal (DIP) joint and the PIP joint. Gesture 208 may be referred to as a DIP-PIP gesture. A human user may use the gesture 208, e.g., by bending a finger and touching the display screen 111 with the part of the finger between the DIP joint and the PIP joint. Gesture 208 may be associated with a size between 0.8 cm*1.6 cm and 0.8 cm*2.4 cm. Gesture 208 includes a larger area than that associated with the finger gesture 206.

The thumb palm gesture 210 may use the part of the palm associated with the bones of the thumb. Thumb palm gesture 210 may be associated with a size between 2.4 cm*1.6 cm and 3.2 cm*3.2 cm, which is larger than an area associated with gesture 208. A user may use the thumb palm gesture 210 by touching the display screen 111 with the fleshy area of the palm that covers the bones of the thumb.

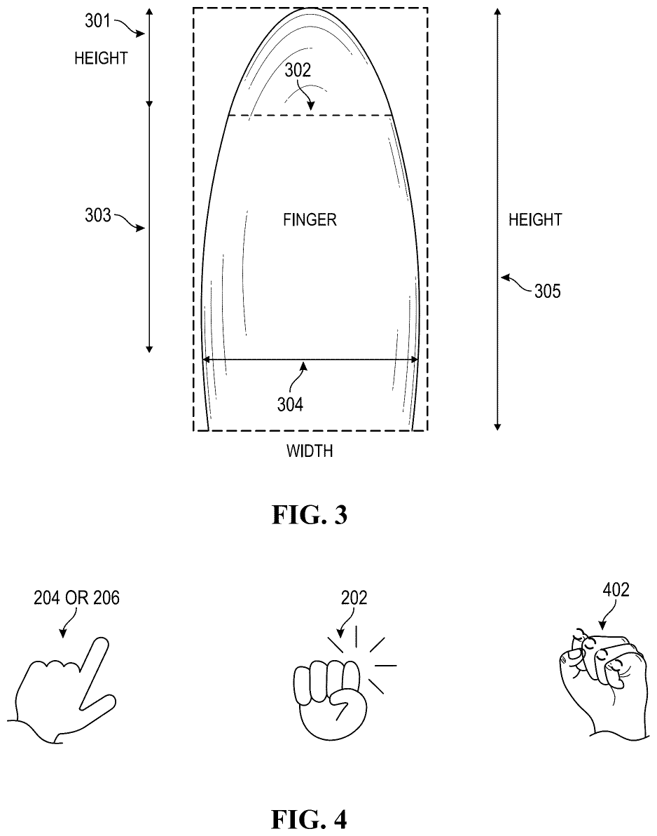

FIG. 3 is an illustration of X and Y coordinates (width and height coordinates), that may be sensed by sense nodes of display screen 111, according to some embodiments. For instance, a fingertip gesture 204 may be associated with a width 302 and a height 301. By contrast, a finger gesture 206 may be associated with a width 304 and a height 303. A DIP-PIP gesture 208 may be associated with a width 304 and a height 305. A thumb palm gesture 210 may be associated with a width and a height that are larger than 304 and 305. A knuckle PIP gesture 202 may be associated with a width and a height that are smaller than 302 and 301. Of course, the example gestures of FIG. 2 are associated with example sizes, and a particular user may have a different sized hand and may be able to calibrate gesture application 115 to recognize the same gestures but having sizes outside of the example ranges.

Returning to FIG. 2, the gesture application 115 may associate each of the different gestures 202, 204, 206, 208, 210 with an action to be performed. In the example of FIG. 2, a user may use a drawing application that is separate from or integrates gesture application 115. The drawing application may allow for the human user to draw a line upon display screen 115 by using hand gestures, and a width of the line may be determined by the hand gesture used by the human user. There may be a menu of pre-defined line widths, such as smallest, small, medium, large, and largest. A user may select a smallest line with by using a knuckle PIP gesture 202, may select a small line with using a fingertip gesture 204, may select a medium line with using a finger gesture 206, may select a large line with using a DIP-PIP gesture 208, and may select a largest line with using the thumb palm gesture 210. Of course, those are just examples, and gesture application 115 may be programmed to associate any appropriate touch gesture with any appropriate action.

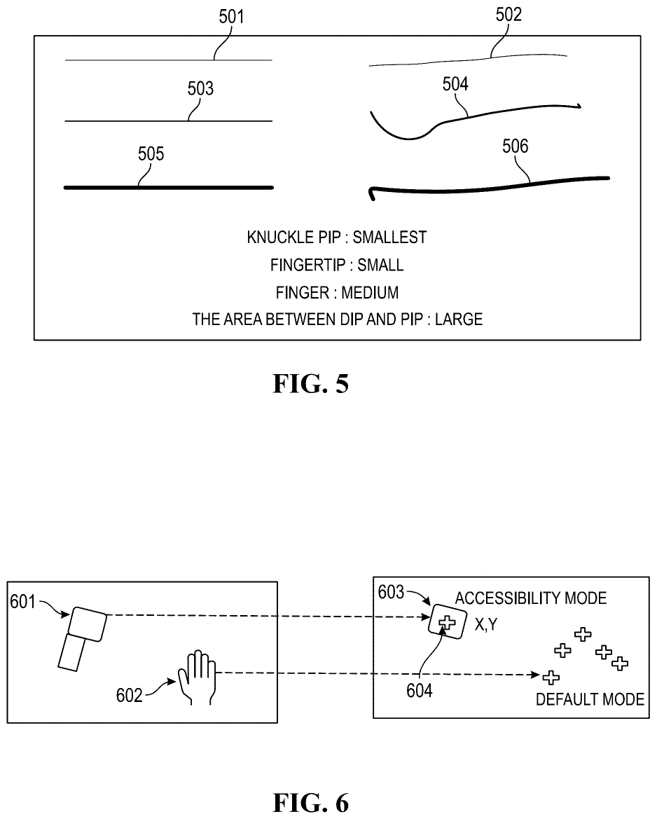

FIG. 5 is an illustration of example lines, drawn by a human user upon a display screen, such as display screen 111, and using gesture application 115, according to some embodiments. Lines 501 and 502 are of a smallest line with, and they may be made by the human user using knuckle PIP gesture 202. Line 503 is of a small width, and it may be made by a human user using fingertip gesture 204. Line 504 is of a medium width, and it may be made by a human user using finger gesture 206. Lines 505 and 506 are of a large line width, and they may be made by a human user using the DIP-PIP gesture 208.

Of course, those are only examples of actions that may be performed in response to the gesture application 115 detecting a particular one of the size-based touch gestures of FIG. 2. In another example, gesture application 115 may allow for a menu of different colors, with each of the size-based touch gestures associated with a different drawing color. A user may select a particular color by using a selected one of the size-based touch gestures.

In one particular example a user may employ multiple line widths within a signature. Such strategy may allow a user to differentiate her signature from signatures of other users, thereby increasing security. Of course, the scope of implementations may include using different line widths for any appropriate purpose.

The scope of implementations also is not limited to drawing applications, as the size-based touch gestures may be applied for other applications. In one example, a finger touch gesture 206 may be used to select an item (e.g., used as a left mouse click), and a knuckle PIP gesture 202 may be used as a right mouse click or a double-click. In another example, a knuckle PIP gesture 202 may be used to draw a letter on a screen to cause an associated application to open on the screen. For instance, a human user drawing a letter “C” using the knuckle PIP gesture 202 may open a camera or a calculator, and drawing a letter “W” using the knuckle PIP gesture 202 may open a word processor application. Of course, any appropriate application and any appropriate gesture or letter may be used. In yet another example, a knuckle PIP gesture 202 may be used to draw a box around a portion of the screen of display device 111, thereby performing a screen capture. In another example, a multiple knuckle touch gesture (e.g., a double knuckle touch gesture or gesture 402) may be used to perform a video capture, perform a copy and paste shortcut, crop an image, control a game, and/or the like. It is within the scope of embodiments to associate any touch gesture with any action, whether it is launching an application, drawing, shortcut functions, video and drawing editing functions, gaming functions, and the like.

As noted above, a user may train or calibrate gesture application 115 on the user's finger touch input by touching upon the screen, causing the different finger touch input to be associated with different size-based touch gestures. In such an embodiment, gesture application 115 may associate those touch gestures with the user's profile. Other users may train or calibrate gesture application 115 on their respective profiles, thereby creating multiple different user profiles.

Thus, in one example, when two human users work on a touch display, e.g., educational gaming touch display), the gesture application 115 may be able to distinguish the two different human users by recognizing their physical touches on the screen to stored profiles of each of the individuals. When the application 115 detects two different finger touch sizes, the gesture application 115 may recognize that as two different human users and perform an appropriate action. An appropriate action may include setting two separate tasks, one for each user, providing two cursors, one for each user, and/or the like.

In another example use of gesture application 115, application 115 may perform rejection mode on some touch gestures. For instance, the gesture application 115 may be working with a human user to recognize that human user's gestures and to perform appropriate actions in response thereto. However, during the human user's use, the gesture application 115 may detect a touch that is different from any of the touches associated with the human user. Such a touch may be associated with another human (e.g., a child having a much differently sized hand) or an animal (e.g., a pet cat or dog). The application 115 may be configured to ignore or reject those touches that are different from a current user's touch gestures.

FIG. 6 is an illustration of an accessibility mode, which may be associated with gesture application 115, according to some embodiments. As noted above, a user may calibrate or train gesture application 115 on multiple size-based touch gestures, such as those discussed above with respect to FIG. 2. Furthermore, the flexibility offered by the calibration and training of gesture application 115 may allow for a more flexible approach with respect to an accessibility mode for people whose hands may have disabilities or may be missing parts.

A user may select an accessibility mode and then train or calibrate the gesture application 115 on the particular user's hand. The user may set one or more touch gestures, which the gesture application 115 may store in the store of category data. From that point on, the gesture application 115 may be configured to recognize the one or more touch gestures of the user. Since the user's hand may not have full functionality or five intact fingers, the gestures may be different from the gestures discussed above with respect to FIG. 2.

FIG. 6 shows an example of a fully functional hand 602 having five intact fingers. By contrast, hand 601 is shown using blocks to approximate a hand that may have lost some or all of its fingers and may not have any touch surfaces that are the same as or similar to knuckles, fingers, or thumb palms.

During calibration, the hand 601 may touch display screen 111, and that touch may be detected by an array of sense nodes. During accessibility mode training or calibration, the gesture application 115 may detect multiple individual touches and/or a wide area of skin touching display screen 111. A relatively wide area with perhaps multiple touches is illustrated by touch zone 603. Accessibility mode may be configured so that the touch zone 603 is associated with a width and height. Furthermore, the gesture application 115 may calculate a center of mass 604 of the touch zone. The gesture application 115 may store the width and height and center of mass 604 in the store of category data. By contrast, when not in accessibility mode, the gesture application 115 would instead detect multiple individual touches, such as illustrated by “default mode”.

During use, and assuming the user has selected accessibility mode, the gesture application 115 may recognize the user's touch, according to the calibration or training. The center of mass 604, which is detected in areas such as zone 603, may be used as a click position on gesture application 115. During accessibility mode, a given user may calibrate or train any appropriate quantity of gestures to be recognized.

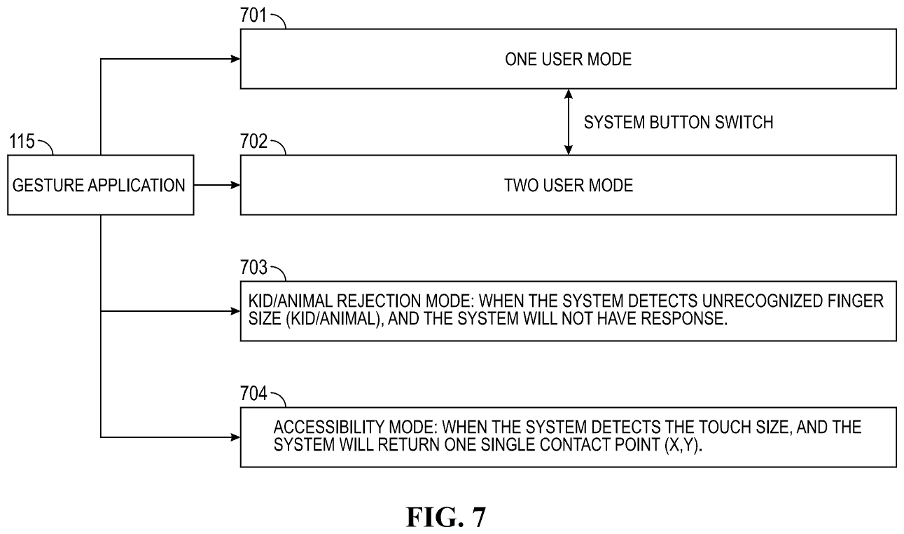

FIG. 7 is an illustration of different example modes 701-704, which may be implemented by gesture application 115, according to some embodiments. Mode 701 includes a one user mode. An example of a one user mode includes gesture application 115 supporting one or multiple user profiles, and a single user at a time employing that profile to use different size-based touch gestures. Examples of size-based touch gestures are discussed above with respect to FIGS. 2-6.

Mode 702 includes a two user mode. For instance, the gesture application 115 may support multiple user profiles, and two users, each having a respective profile, may use the display device 111 at the same time. Users may switch between the one user mode 701 and the two user mode 702 using any appropriate technique, such as a system button switch. In two user mode 702, the gesture application 115 may recognize two different users, corresponding to two respective profiles, and may allow for multiple cursors and multiple inputs simultaneously to accommodate the two users.

Mode 703 includes a child or animal rejection mode. For instance, when the gesture application 115 detects an unrecognized touch size, and during use by another user, the gesture application 115 may disregard the touch or otherwise ignore the touch.

Mode 704 includes an accessibility mode, such as discussed above with respect to FIG. 6. In these examples, the gesture application 115 may operate in multiple ones of the modes 701-704 at the same time. For instance, mode 701 may be used at the same time as modes 703 and 704, and mode 702 may be used at the same time as modes 703 and 704. The scope of implementations may include any appropriate quantity of modes and any appropriate quantity of simultaneously-employed modes.

An advantage of some embodiments may include the gesture application 115 may provide sufficient flexibility to support multiple modes, such as modes 701-704. The multiple modes 701-704 may allow for increased usability of a graphical user interface upon a display device, such as display device 111.

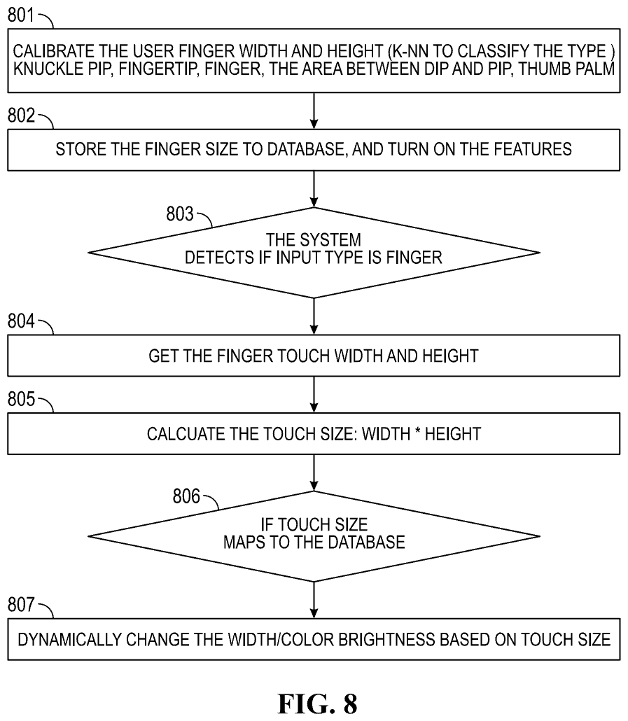

FIG. 8 is an illustration of example method 800, which may be performed by gesture application 115, according to some embodiments. For instance, in the IHS 100 of FIG. 1, the processors 101 may read and execute computer executable code from the system memory 103 to perform the functionality of gesture application 115. Gesture application 115 may receive touch input data from display device 111, via display controller 104. Gesture application 115 may then analyze the touch input data, classify the touch input data as a particular size-based touch gesture, and may then control an action of the IHS 100, such as controlling and output upon display device 111.

At action 801, the gesture application 115 may calibrate the user finger width and height, such as by receiving user input upon display device 111. In one example, the application 115 may employ a k-NN learning model or other appropriate learning model to classify different touch input as different size-based touch gestures.

At action 802, the application 115 may store the finger size data (e.g., the calibration and/or training data) to a database. In this manner, the application 115 may maintain a store of category data, where the category data defines a plurality of size-based touch gestures, at least for one user. For instance, the gesture application 115 may store training data and/or calibration data which allows gesture application 115 to categorize user interaction during normal use as one or more of the size-based touch gestures.

Thus, actions 801-802 represent the calibration and/or training operation, including maintaining the store of category data. Actions 803-807 represent normal use of the calibrated and/or trained gesture application 115.

At action 803, the gesture application 115 detects if an input type is a finger. For instance, there may be a touch detected on a display screen, where that touch may be so different from known touch gestures that the application 115 may reject the touch. An example may be a touch by an animal, an elbow, a child, or the like. Action 803, if the input type is rejected, the gesture application 115 may simply ignore it and perform no action in response to the touch. On the other hand, if the gesture application 115 determines that the detected touch is a finger, then it may move on to action 804.

At action 804, the gesture application 115 may receive width and height data from, e.g., display controller 104. The width and height data may be in terms of a quantity of sense nodes in an array of sense nodes, and further may be in terms of an X and Y dimension. In other embodiments, the width and height may be in some other terms, such as distance units or other appropriate units. At action 805, the application 115 may calculate the touch size, such as by multiplying a width and height. In some examples, the width and height of action 804 may represent shape data, whereas the touch size of action 805 may represent touch size data.

At action 806, the gesture application 115 may attempt to classify the touch according to the category data that is stored to the database, such as discussed above at action 802. For instance, the gesture application 115 may use the size data from action 805 to determine whether the touch corresponds to one or more size-based touch gestures that are defined in the database. Different size-based touch gestures are discussed above with respect to FIG. 2, though the scope of embodiments may allow for any appropriate quantity and type of touch gestures that are supported by gesture application 115. Additionally, if the gesture application 115 is in accessibility mode, action 806 may include determining a center of mass of the touch gesture and defining the center as a single touch point.

In a scenario in which the touch does not correspond to any defined size-based touch gestures of the database, then application 115 may perform an appropriate action, such as ignoring the touch, providing an error signal, and/or the like. Assuming that the gesture application 115 successfully classifies the touch according to the category data, then the application 115 may move to action 807.

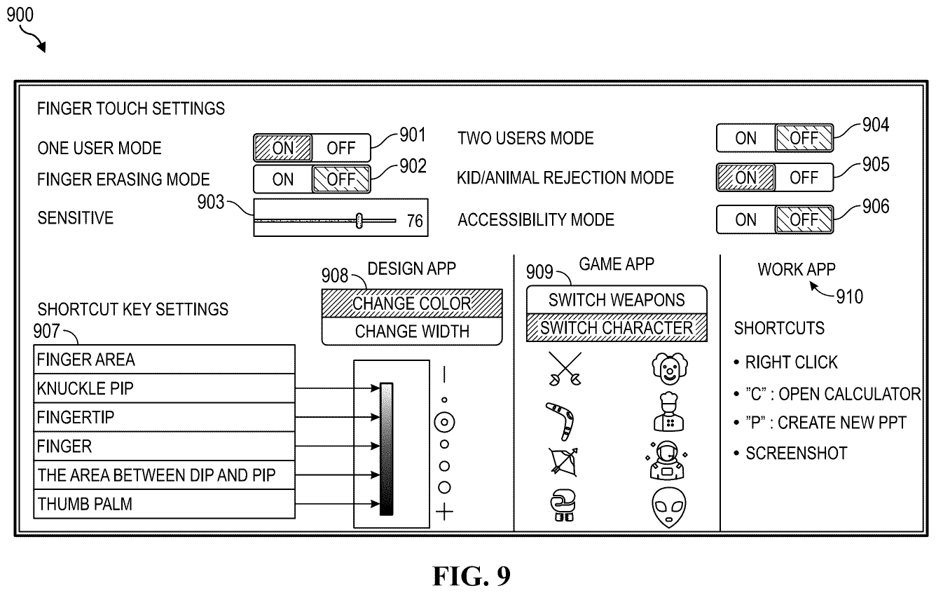

At action 807, the application 115 may control an action of the display screen based upon determining that the user interaction corresponds to one or more of the defined size-based touch gestures. As noted above, the application 115 may allow for different ones of the size-based touch gestures to be associated with one or more actions to be performed by the IHS. In the example of FIG. 5, different size-based touch gestures may be mapped to different line widths or different line colors in a drawing application, though the scope of implementations is not so limited. Rather, other actions may include launching a particular application or the like. Different actions that may be performed at action 807 are described in more detail with respect to FIG. 9.

FIG. 9 is an illustration of an example settings screen 900, which may be displayed upon a graphical user interface on a display device, such as display device 111 of FIG. 1, according to various embodiments. A human user may interact with settings screen 900 to set various settings and preferences for action by an IHS, which may support a variety of different size-based touch gestures. For instance, a human user may use settings screen 900 to select settings and preferences to be applied to a gesture application, such as gesture application 115.

Switch 901 may allow a human user to turn on or off a one user mode, whereas switch 904 may allow the user to turn on or off a two user mode. Switch 902 may allow a user to turn on or off a finger erasing mode. For instance, a finger touch gesture (e.g., gesture 206 of FIG. 2) may be associated with an erase operation on a drawing application, and switch 902 may allow a user to turn that action on or off. Switch 905 may allow the human user to turn the child or animal rejection mode on or off. Switch 906 may allow the human user to turn accessibility mode on or off, where accessibility mode was discussed above in more detail with respect to FIG. 6.

Slider 903 may allow the human user to set a sensitivity of display controller 104 in determining which sense nodes to consider as having been touched or not touched. For instance, a human user may set slider 903 to an appropriate level that works well with the way the human user is accustomed to touching the display device. Some users may have better performance with a lower sensitivity, whereas other users may have better performance with a higher sensitivity, and a particular user may determine the sensitivity level there any appropriate technique, such as trial and error.

Shortcut key settings table 907 lists different size-based touch gestures, which may be recognized by a gesture application. Each of those size-based touch gestures in table 907 may then be mapped to different actions using selection buttons 908 and 909. For instance, selection button 908 may be associated with a design drawing application, and it may map the different size-based touch gestures to different line widths or different line colors, and the selection button 908 may allow a human user to select between line color mapping and align with mapping.

Selection button 909 may be associated with gaming applications, and it may associate different ones of the size-based touch gestures to different weapons and different characters. A human user may use selection button 909 to choose whether the size-based touch gestures cause a switch in character or a switch in weapons when using gaming applications.

Selection menu 910 may be associated with different work applications (e.g., word processors, spreadsheets, presentation applications), and it may allow a human user to select shortcuts to be associated with different ones of the size-based touch gestures. For instance, selection menu 910 may allow a human user to associate one of the size-based touch gestures with a right-click, versus a left click. Selection menu 910 may allow a human user to draw a character using, e.g., a knuckle PIP gesture, to cause the IHS 100 to launch a particular application. In one example, the user may draw the character “C” using a knuckle PIP gesture to launch a calculator or to draw the character “P” using the knuckle gesture to launch a presentation application. In another example, the human user may use the menu 910 to map one of the size-based touch gestures to a screenshot or other appropriate copying action. Of course, the scope of implementations may allow for a human user to map any character and any of the size-based touch gestures to any appropriate action.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

In many implementations, systems and methods described herein may be incorporated into a wide range of electronic devices including, for example, computer systems or Information Technology (IT) products such as servers, desktops, laptops, memories, switches, routers, etc.; telecommunications hardware; consumer devices or appliances such as mobile phones, tablets, wearable devices, IoT devices, television sets, cameras, sound systems, etc.; scientific instrumentation; industrial robotics; medical or laboratory electronics such as imaging, diagnostic, or therapeutic equipment, etc.; transportation vehicles such as automobiles, buses, trucks, trains, watercraft, aircraft, etc.; military equipment, etc. More generally, these systems and methods may be incorporated into any device or system having one or more electronic parts or components.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination thereof. Such configured devices are physically designed to perform the specified operation(s).

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. A method comprising:
maintaining a store of category data, wherein the category data defines a plurality of size-based touch gestures;
detecting user interaction with a touch-sensitive display screen;
classifying the user interaction according to the category data, including determining that the user interaction corresponds to a first size-based touch gesture of the plurality of size-based touch gestures; and
controlling an action of the touch sensitive display screen based upon determining that the user interaction corresponds to the first size-based touch gesture.

2. The method of claim 1, wherein the plurality of size-based touch gestures defines a plurality of finger part gestures.

3. The method of claim 1, wherein classifying the user interaction according to the category data comprises:
determining a closest match between size data associated with the user interaction and the plurality of size-based touch gestures.

4. The method of claim 1, wherein maintaining the store of category data comprises:
training a machine learning (ML) model on a plurality of different finger parts of a human user; and
storing the trained ML model into the store of category data.

5. The method of claim 1, wherein the plurality of size-based touch gestures comprises:
a fingertip gesture;
a knuckle gesture; and
a distal interphalangeal joint-proximal interphalangeal joint gesture.

6. The method of claim 1, wherein controlling the action of the touch sensitive display screen comprises:
determining a line width for drawing.

7. The method of claim 1, wherein controlling the action of the touch sensitive display screen comprises:
determining a line color for drawing.

8. The method of claim 1, wherein controlling the action of the touch sensitive display screen comprises:
opening an application on the display screen, wherein the application is selected based on the first size-based touch gesture.

9. The method of claim 1, further comprising:
detecting a second user interaction;
classifying the second user interaction according to the category data, including determining that the second user interaction corresponds to a second size-based touch gesture of the plurality of size-based and touch gestures; and
determining that the second user interaction is not associated with a human user corresponding to the user interaction; and
ignoring the second user interaction.

10. The method of claim 1, further comprising:
detecting a second user interaction;
classifying the second user interaction according to the category data, including determining that the second user interaction corresponds to a second size-based touch gesture of the plurality of size-based and touch gestures; and
determining that the second user interaction is not associated with a human user corresponding to the user interaction; and
associating the second user interaction with a second user profile different from a first user profile of the human user corresponding to the user interaction.

11. The method of claim 1, wherein a second size-based touch gesture of the plurality of size-based touch gestures corresponds to a part of a hand that is not a finger, and wherein maintaining the store of category data comprises:
generating a profile of the part of the hand that is not a finger, including calibrating an application based on a width and height of a touch pattern of the part of the hand that is not a finger; and
store the profile to the store of category data as the second size-based touch gesture.

12. An Information Handling System (IHS), comprising:
a processor; and
a memory coupled to the processor, the memory having program instructions stored thereon that, upon execution by the processor, cause the IHS to:
receive digital input corresponding to a physical touch by a part of a human hand upon a display screen of the IHS;
classify the physical touch as a first size-based touch gesture, from a plurality of size-based touch gestures, including performing a matching operation between the physical touch and a store of data that defines the plurality of size-based touch gestures; and
perform a first action upon the display screen, wherein the first action has been pre-programmed to correspond to the first size-based touch gesture.

13. The IHS of claim 12, wherein the program instructions to cause the IHS to perform a matching operation between the physical touch and the store of data comprises program instructions to cause the IHS to: classify a width and a height of the physical touch according to the store of data that defines the plurality of size-based touch gestures.

14. The IHS of claim 12, wherein the plurality of size-based touch gestures further includes a second size-based touch gesture, wherein the second size-based touch gesture is defined by the store of data to be larger than the first size-based touch gesture.

15. The IHS of claim 12, wherein the plurality of size-based touch gestures includes a knuckle touch gesture and a thumb palm touch gesture, both of which are defined by the store of data as being different from the first size-based touch gesture.

16. The IHS of claim 12, wherein the program instructions to cause the IHS to classify the physical touch comprises program instructions to cause the IHS to: match the digital input to the store of data, wherein the store of data includes a training data set and associated class labels of a k-nearest neighbors (KNN) algorithm.

17. The IHS of claim 12, wherein the program instructions to cause the IHS to perform the first action upon the display screen comprises program instructions to cause the IHS to: determine a line width or line color based upon classifying the physical touch as the first size-based touch gesture.

18. A hardware memory device having program instructions stored thereon that, upon execution by a processor of an Information Handling System (IHS), cause the IHS to:
receive digital input corresponding to a physical touch by a part of a human hand upon a display screen of the IHS, wherein the digital input identifies a width and a height of the physical touch;
perform a matching operation on the digital input with respect to a plurality of pre-defined size-based touch gestures, including determining that the width and the height of the physical touch matches a first size-based touch gesture of the plurality of pre-defined size-based touch gestures; and
perform a first action upon the display screen, wherein the first action has been pre-programmed to correspond to the first size-based touch gesture.

19. The hardware memory device of claim 18, further comprising program instructions to cause the IHS to:
display a settings screen on the display screen of the IHS;
receive user input on the display screen; and
apply the user input to associate the first size-based touch gesture with the first action.

20. The hardware memory device of claim 18, further comprising program instructions to cause the IHS to:
receive user input indicating a switch to an accessibility mode;
in response to being in the accessibility mode, receive a second physical touch upon the display screen of the IHS;
determine that the second physical touch has a width and a height and a center of mass; and
associate the center of mass with a click position upon the display screen.
